(19) United States
(12) Patent Application Publication
(10) Pub. No.: US 2023/0068234 A1
(43) Pub. Date: Mar. 2, 2023

(54) METHOD FOR MANUFACTURING RIBBON PIECE

(71) Applicants: Akinori TOMIOKA, Nagoya-shi (JP); Takuya SUKEDA, Toyota-shi (JP); Naoki HIRAI, Miyoshi-shi (JP); Yoshikiyo KONDO, Kamo-shi (JP); Masaaki SHIMIZU, Sanjo-shi (JP); Isamu SAKAYORI, Tokyo (JP); Kojiro KATAOKA, Tokyo (JP); Hiroshi MISONO, Tokyo (JP)

(72) Inventors: Akinori TOMIOKA, Nagoya-shi (JP); Takuya SUKEDA, Toyota-shi (JP); Naoki HIRAI, Miyoshi-shi (JP); Yoshikiyo KONDO, Kamo-shi (JP); Masaaki SHIMIZU, Sanjo-shi (JP); Isamu SAKAYORI, Tokyo (JP); Kojiro KATAOKA, Tokyo (JP); Hiroshi MISONO, Tokyo (JP)

(73) Assignees: TOYOTA JIDOSHA KABUSHIKI KAISHA, Toyota-shi (JP); SANJO MACHINE WORKS, LTD., Sanjo-shi (JP); KOTO ENGRAVING CO., LTD., Tokyo (JP)

(21) Appl. No.: 17/892,624

(22) Filed: Aug. 22, 2022

(30) Foreign Application Priority Data
Aug. 27, 2021 (JP) 2021-139261

(51) Int. Cl. B21D 28/12

(52) U.S. Cl. CPC B21D 28/12

(57) ABSTRACT

Provided is a method for manufacturing a ribbon piece that allows suppressing a damage of a rotary die cutter. A method for manufacturing a ribbon piece of the present disclosure includes punching out a ribbon piece from a ribbon material using a rotary die cutter. The rotary die cutter includes a die roll and an anvil roll. The die roll includes a die roll body, and a cutting blade is formed to protrude on an outer peripheral surface of the die roll body. The anvil roll includes an anvil roll body, a groove is provided on an outer peripheral surface of the anvil roll body, and the cutting blade is engageable with the groove with a space. In the punching, the ribbon material is cut by engaging the cutting blade of the die roll body with the groove of the anvil roll body with a space and pressing the cutting blade of the die roll body onto the ribbon material while sandwiching and pressing the ribbon material between a die roll side elastic body disposed in both sides of a base portion of the cutting blade on the outer peripheral surface of the die roll body and both sides of the groove of the outer peripheral surface of the anvil roll body when the ribbon material is passed through between the die roll and the anvil roll.

### CROSS REFERENCE TO RELATED APPLICATIONS

The present application claims priority from Japanese patent application JP 2021-139261 filed on Aug. 27, 2021, the entire content of which is hereby incorporated by reference into this application.

### BACKGROUND

### Description of Related Art

The present disclosure relates to a method for manufacturing a ribbon piece by punching the ribbon piece from a ribbon material using a rotary die cutter.

### Background Art

Conventionally, it is often required to manufacture a ribbon piece in a predetermined shape from a ribbon material, such as a metal thin plate, a metal ribbon, and a metal foil, containing a metallic material and the like. This is because components mounted to various machines and electronic equipment are often formed from the ribbon pieces having predetermined shapes. Specifically, for example, as disclosed in WO 2017/006868, a laminated core used for a motor core and the like is formed by laminating ribbon pieces processed from an amorphous alloy ribbon or the like. Furthermore, most of electrodes included in secondary batteries and fuel cells are formed from metal ribbon pieces.

As a processing method for manufacturing a ribbon piece in a predetermined shape from a ribbon material, while press punching has been conventionally applied, recently, from the aspect of improving the productivity and the like, a processing method using a rotary die cutter has been applied.

As the processing method using a rotary die cutter, for example, Japanese Patent No. 6037690 discloses a processing method using a rotary cutter that punches an extremely thin metal material (ribbon material), such as a metal thin plate and a metal foil, in a predetermined shape by a shearing work. The rotary cutter includes a first rotating member, a second rotating member, and an elastic body. In the rotary cutter, the first rotating member is provided with at least one of a protruding portion or a recessed portion on its surface. The second rotating member is rotatable in an opposite direction of the first rotating member, and provided with at least one of a protruding portion or a recessed portion on its surface. The elastic body is mounted to at least a part of a stepped portion of an edge formed by the protruding portion or the recessed portion provided to the first rotating member. Furthermore, the elastic body is mounted to at least a part of a stepped portion of an edge formed by the protruding portion or the recessed portion provided to the second rotating member. The metal material is sheared between the edge of the first rotating member and the edge of the second rotating member.

Furthermore, as the processing method using a rotary die cutter, for example, JP 2017-132019 A discloses a processing method using a die cutting device that includes a rotary die and an anvil roll. In the device, the rotary die includes a die cut roll and a cutting blade having a shape projecting outward in a radial direction of the die cut roll. The cutting blade includes a pair of first cutting portions having shapes projecting from an outer peripheral surface along a circumferential direction of the die cut roll. The cutting portions are disposed to be separated in an axial direction of the die cut roll. Furthermore, the rotary die includes sponges between which the first cutting portions are sandwiched in the axial direction of the die cut roll, and the sponge has a compression ratio set to 40% or more at a position at which a separation distance between the die cut roll and the anvil roll is the shortest. In the die cutting device, the cutting blade of the rotary die is entered to a ribbon material of an electrode intermediate or the like when the electrode intermediate is passed through between the rotary die and the anvil roll, thereby cutting the ribbon material along a scheduled cutting line, thus manufacturing a ribbon piece in a predetermined shape from the ribbon material.

### SUMMARY

In contrast, for example, since a ribbon material such as an amorphous alloy ribbon or the like has a high hardness and a low ductility, its cutting is not easy. In view of this, when punching a ribbon material having a high hardness and a low ductility by a shearing work using a rotary die cutter like the rotary cutter as disclosed in Japanese Patent No. 6037690, the rotary die cutter is easily damaged because its abrasion progresses in an early stage.

Furthermore, also when punching a ribbon piece from a ribbon material by cutting the ribbon material with a cutting blade using a rotary die cutter like the die cutting device disclosed in JP 2017-132019 A, the rotary die cutter is easily damaged due to a strong load applied to the cutting blade when the ribbon material has a high hardness and a low ductility.

The present disclosure is made in view of the above-described points, and provides a method for manufacturing a ribbon piece by punching the ribbon piece from a ribbon material using a rotary die cutter, and the method for manufacturing a ribbon piece allowing suppressing a damage of the rotary die cutter.

To solve the above-described problem, a method for manufacturing a ribbon piece (a thin strip) of the present disclosure comprises punching out a ribbon piece (a thin strip) from a ribbon material (a thin belt material) using a rotary die cutter. The rotary die cutter includes a die roll and an anvil roll. The die roll includes a die roll body, and a cutting blade, the shape of which corresponds to a peripheral edge of the ribbon piece, is formed to protrude on an outer peripheral surface of the die roll body. The anvil roll includes an anvil roll body, a groove is provided on an outer peripheral surface of the anvil roll body, and the cutting blade of the die roll body is engageable with the groove with a space. In the punching, the ribbon material is cut by engaging the cutting blade of the die roll body with the groove of the anvil roll body with a space and pressing the cutting blade of the die roll body onto the ribbon material while sandwiching and pressing the ribbon material between a die roll side elastic body disposed in both sides of a base portion of the cutting blade on the outer peripheral surface of the die roll body and both sides of the groove of the outer peripheral surface of the anvil roll body when the ribbon material is passed through between the die roll and the anvil roll by rotating the die roll and the anvil roll in mutually opposite directions, so as to punch out the ribbon piece from the ribbon material.

### Effect

The present disclosure allows suppressing the damage of the rotary die cutter.

### BRIEF DESCRIPTION OF THE DRAWINGS

FIG. 1 is a side view schematically illustrating manufacturing equipment to perform a method for manufacturing a ribbon piece according to a first embodiment;

FIG. 2 is a schematic plan view illustrating a ribbon piece punched out from a ribbon material using the method for manufacturing a ribbon piece according to the first embodiment;

FIG. 3A is a process cross-sectional view schematically illustrating a punching step in the method for manufacturing a ribbon piece according to the first embodiment;

FIG. 3B is a process cross-sectional view schematically illustrating the punching step in the method for manufacturing a ribbon piece according to the first embodiment;

FIG. 4 is an enlarged view of a part X illustrated in FIG. 3B, and is a drawing for describing a mechanism of cutting the ribbon material in the punching step;

FIG. 5 is a process cross-sectional view schematically illustrating a main part of a punching step in a method for manufacturing a ribbon piece according to a modification of the first embodiment;

FIG. 6 is a side view schematically illustrating manufacturing equipment to perform a method for manufacturing a ribbon piece according to a second embodiment;

FIG. 7A is a process cross-sectional view schematically illustrating a punching step in the method for manufacturing a ribbon piece according to the second embodiment;

FIG. 7B is a process cross-sectional view schematically illustrating the punching step in the method for manufacturing a ribbon piece according to the second embodiment; and

FIG. 8 is a process cross-sectional view schematically illustrating a main part of a punching step in a method for manufacturing a ribbon piece according to a modification of the second embodiment.

### DETAILED DESCRIPTION OF THE EMBODIMENTS

The following describes methods for manufacturing a ribbon piece according to embodiments.

First, the outline of the methods for manufacturing a ribbon piece according to the embodiments will be described with examples of the method for manufacturing a ribbon piece according to a first embodiment and a second embodiment.

### First Embodiment

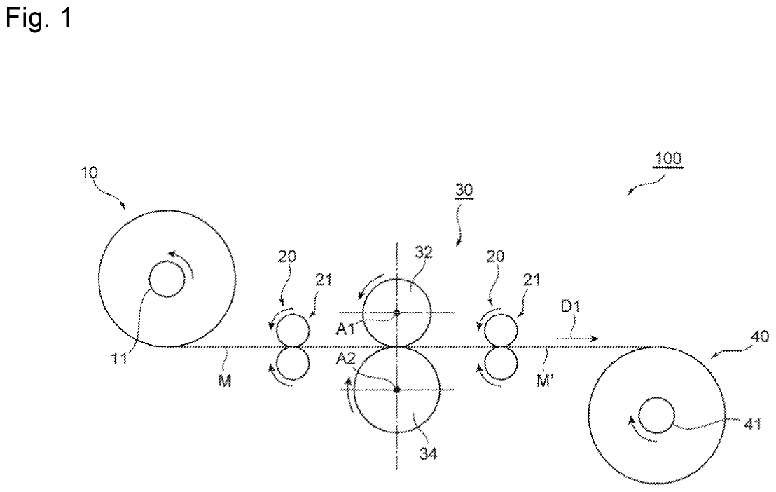

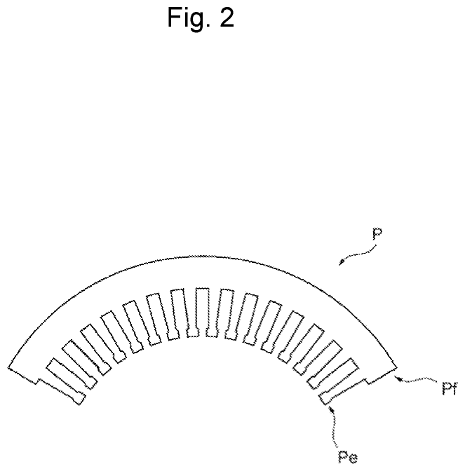

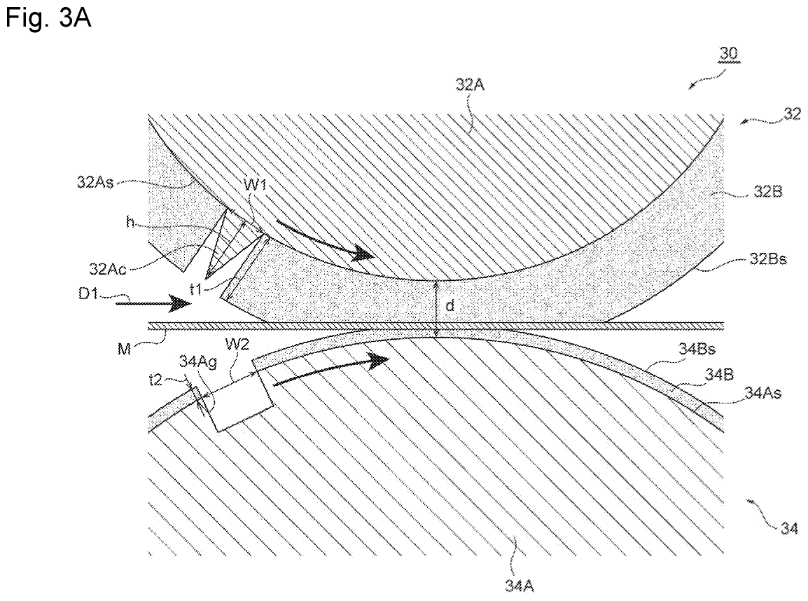

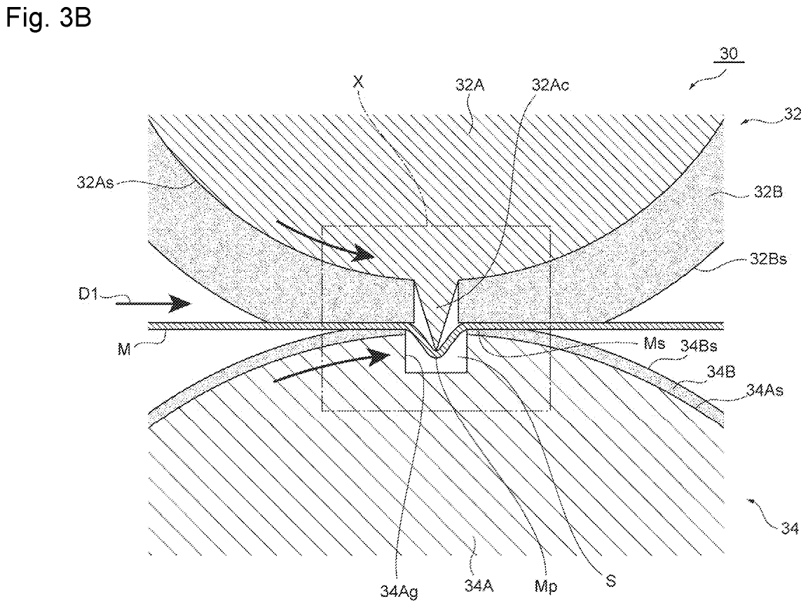

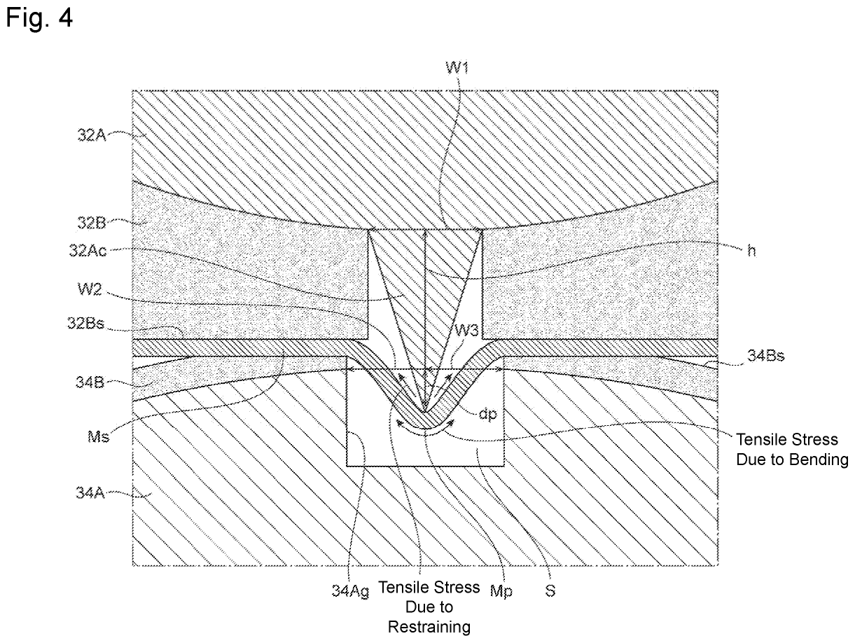

FIG. 1 is a side view schematically illustrating manufacturing equipment to perform a method for manufacturing a ribbon piece according to the first embodiment. FIG. 2 is a schematic plan view illustrating a ribbon piece punched out from a ribbon material using the method for manufacturing a ribbon piece according to the first embodiment. FIG. 3A and FIG. 3B are process cross-sectional views schematically illustrating a punching step in the method for manufacturing a ribbon piece according to the first embodiment. FIG. 4 is an enlarged view of a part X illustrated in FIG. 3B, and is a drawing for describing a mechanism of cutting the ribbon material in the punching step.

As illustrated in FIG. 1, manufacturing equipment 100 to perform the method for manufacturing a ribbon piece according to the first embodiment includes a material supply device 10, a rotary die cutter 30, and a material collection device 40, which are sequentially disposed in a conveyance direction D1. The manufacturing equipment 100 further includes two material conveyance devices 20, which are disposed in respective upstream side and downstream side of the rotary die cutter 30 in the conveyance direction D1.

The material supply device 10 includes a rotation shaft 11 disposed to be rotatable in an arrow direction so as to unroll a ribbon material (a thin belt material) M and supply the ribbon material M to the rotary die cutter 30. The ribbon material M is wound around the rotation shaft 11. The ribbon material M is an amorphous alloy ribbon. The material conveyance device 20 includes a pair of conveyance rolls 21 that rotate while sandwiching the ribbon material M therebetween. The pair of conveyance rolls 21 are disposed so as to have rotation axes parallel to one another, and rotate in mutually opposite directions as indicated by arrows, thus conveying the ribbon material M while sandwiching the ribbon material M therebetween. The material collection device 40 includes a rotation shaft 41 disposed to be rotatable in an arrow direction so as to roll up and collect a punched ribbon material M′.

In the manufacturing equipment 100, first, the ribbon material M supplied from the material supply device 10 is conveyed to the rotary die cutter 30 by the material conveyance device 20 in the upstream side. Next, a method for manufacturing a ribbon piece (a thin strip) according to the first embodiment is performed by the rotary die cutter 30, thereby manufacturing a ribbon piece (a thin strip) P illustrated in FIG. 2 from the ribbon material M by punching. The ribbon piece P is obtained by further circumferentially dividing a ribbon piece constituting each layer of a laminated stator core, and the ribbon piece P includes a comb-shaped peripheral edge Pe and a flat peripheral edge Pf in the opposite side of the peripheral edge Pe. Next, the punched ribbon material M′ is conveyed to the material collection device 40 by the material conveyance device 20 in the downstream side, and collected by the material collection device 40. The following describes the rotary die cutter 30 and the method for manufacturing a ribbon piece according to the first embodiment in detail.

As illustrated in FIG. 1, FIG. 3A, and FIG. 3B, the rotary die cutter 30 includes a die roll 32 and an anvil roll 34. The die roll 32 includes a die roll body 32A and a die roll elastic layer (die roll side elastic body) 32B. The die roll body 32A is a column-shaped die, and rotatably disposed having its central axis parallel to the rotation axis of the conveyance roll 21 as a rotation axis A1. A cutting blade 32Ac is formed on an outer peripheral surface 32As of the die roll body 32A and is protruded from the outer peripheral surface 32As of the die roll body 32A. The shape of the cutting blade 32Ac is a shape corresponding to a peripheral edge of the ribbon piece P (The cutting blade 32Ac has a shape corresponding to a peripheral edge of the ribbon piece P.). That is, when the outer peripheral surface 32As of the die roll body 32A is expanded into a plane (developed into a plane shape), the blade edge of the cutting blade 32Ac is the same as the peripheral edge of the ribbon piece P in shape in plan view. The cutting blade 32Ac has a triangular cross-sectional shape. The die roll elastic layer 32B is disposed to be secured to both sides of a base portion of the cutting blade 32Ac on the outer peripheral surface 32As of the die roll body 32A, and extends to an adjacent region of the base portion of the cutting blade 32Ac. The die roll 32 rotates in an arrow direction about the rotation axis A1 of the die roll body 32A while pressing the ribbon material M by the die roll elastic layer 32B. The anvil roll 34 includes an anvil roll body 34A and an anvil roll elastic layer 34B. The anvil roll body 34A is a column-shaped die, and rotatably disposed having its central axis parallel to the rotation axis A1 as a rotation axis A2. An outer peripheral surface 34As of the anvil roll body 34A is provided with a groove 34Ag, and the cutting blade 32Ac of the die roll body 32A is engageable with (can be loosely fitted into) the groove 34Ag with a space S between the cutting blade 32Ac and the inside surface of the groove 34Ag. The anvil roll elastic layer 34B is disposed to be secured to both sides of the groove 34Ag of the outer peripheral surface 34As of the anvil roll body 34A, and extends to an adjacent region in both sides of the groove 34Ag. The anvil roll 34 rotates in an arrow direction about the rotation axis A2 of the anvil roll body 34A while supporting the ribbon material M by the anvil roll elastic layer 34B.

As illustrated in FIG. 3A, FIG. 3B, and FIG. 4, in the rotary die cutter 30, a width W1 of the base portion of the cutting blade 32Ac of the die roll body 32A is equal to or less than a width W2 of the groove 34Ag of the anvil roll body 34A. The width W2 of the groove 34Ag is set such that a clearance W3 between the blade edge of the cutting blade 32Ac and the edge of the groove 34Ag is increased to, for example, about five times (approximately 0.1 mm to 0.15 mm) of the thickness (approximately 20 μm to 30 μm) of the ribbon material M. The die roll elastic layer 32B has a thickness t1 larger than a height h of the cutting blade 32Ac. Since the die roll elastic layer 32B is made of a resin sponge sheet, and the anvil roll elastic layer 34B is made of a multi-layered sheet of a non-foamed resin, the anvil roll elastic layer 34B has a hardness (Shore A) three times or more of a hardness (Shore A) of the die roll elastic layer 32B. The height h of the cutting blade 32Ac and a clearance d between the roll bodies 32A, 34A are set such that a depth dp of the cutting blade 32Ac pressed into the groove 34Ag is increased to, for example, about five times (approximately 0.1 mm to 0.15 mm) of the thickness of the ribbon material M.

In the method for manufacturing a ribbon piece according to the first embodiment, the ribbon piece P is repeatedly punched out from the ribbon material M using the rotary die cutter 30 (punching step). In the punching step, as illustrated in FIG. 3A and FIG. 3B, the die roll 32 and the anvil roll 34 are rotated in the mutually opposite directions as indicated by the arrows while sandwiching the ribbon material M between an outer peripheral surface 32Bs of the die roll elastic layer 32B and an outer peripheral surface 34Bs of the anvil roll elastic layer 34B. Accordingly, the ribbon material M is passed through between the die roll 32 and the anvil roll 34. At this time, while sandwiching and pressing the ribbon material M between the die roll elastic layer 32B and the anvil roll elastic layer 34B, the cutting blade 32Ac of the die roll body 32A is engaged with (loosely fitted into) the groove 34Ag of the anvil roll body 34A with the space S between the cutting blade 32Ac and the inside surface of the groove 34Ag, and pressed onto the ribbon material M.

Accordingly, as illustrated in FIG. 4, in the adjacent region in both sides of the groove 34Ag of the anvil roll body 34A, a sandwiched portion Ms sandwiched and pressed between the die roll elastic layer 32B and the anvil roll elastic layer 34B in the ribbon material M is restrained by elastic forces of both of the die roll elastic layer 32B and the anvil roll elastic layer 34B. At the same timing, by projecting the cutting blade 32Ac of the die roll body 32A from the outer peripheral surface 32Bs of the die roll elastic layer 32B, a press position Mp of the ribbon material M at which the cutting blade 32Ac is pressed onto the ribbon material M is pressed down by the cutting blade 32Ac of the die roll body 32A. Thus, a tensile stress due to restraining is applied to the press position Mp of the ribbon material M together with a tensile stress due to bending, thereby cutting the ribbon material M at the press position Mp.

By continuously rotating the die roll 32 and the anvil roll 34, the cutting of the ribbon material M as described above is continuously performed to repeatedly punch out the ribbon piece P from the ribbon material M, thereby manufacturing a plurality of the ribbon pieces P.

According to the method for manufacturing a ribbon piece of the first embodiment, by applying the tensile stress due to bending and the tensile stress due to restraining to the press position Mp of the ribbon material M, the ribbon material M is cut at the press position Mp, thereby allowing punching out the ribbon material M. Accordingly, since a strong load applied to the cutting blade 32Ac can be avoided, the damage of the rotary die cutter 30 can be suppressed compared with a case of punching out the ribbon material M by a shearing work.

The width W1 of the base portion of the cutting blade 32Ac of the die roll body 32A is equal to or less than the width W2 of the groove 34Ag of the anvil roll body 34A, and the die roll elastic layer 32B extends to the adjacent region of the base portion of the cutting blade 32Ac. Therefore, the sandwiched portion Ms of the ribbon material M can be restrained by the elastic force of the die roll elastic layer 32B in the adjacent region in both sides of the groove 34Ag of the anvil roll body 34A without a delay to the timing of pressing the cutting blade 32Ac of the die roll body 32A onto the ribbon material M. Accordingly, it can be avoided that the ribbon material M enters the groove 34Ag, thus allowing the tensile stress due to restraining to act on the press position Mp of the ribbon material M with a magnitude enough for the cutting.

Since the ribbon material M can be cut by engaging the cutting blade 32Ac of the die roll body 32A with the groove 34Ag of the anvil roll body 34A with the space S and pressing the cutting blade 32Ac onto the ribbon material M, the clearance W3 between the blade edge of the cutting blade 32Ac and the edge of the groove 34Ag can be increased to, for example, about five times (approximately 0.1 mm to 0.15 mm) of the thickness of the ribbon material M. Accordingly, a phase matching (phase alignment) between the die roll 32 and the anvil roll 34 is facilitated compared with a case where a pair of an upper die and a lower die is used, and for punching the ribbon material M by a shearing work, it is necessary to set a clearance between a punch and a die as the upper die and the lower die to about 10% (approximately several μm) of the thickness of the ribbon material M.

Furthermore, the hardness (Shore A) of the anvil roll elastic layer 34B is three times or more of the hardness (Shore A) of the die roll elastic layer 32B. Therefore, by supporting the ribbon material M by the hard anvil roll elastic layer 34B and pressing the ribbon material M by the soft die roll elastic layer 32B, the deformation of the sandwiched portion Ms of the ribbon material M caused by pressing down the press position Mp of the ribbon material M can be suppressed, thus allowing strongly restraining the sandwiched portion Ms of the ribbon material M. Accordingly, the ribbon material M can be surely cut at the press position Mp, and the ribbon piece P can be punched from the ribbon material M with an accuracy of the shape in plan view of the blade edge of the cutting blade 32Ac.

### (Modification of First Embodiment)

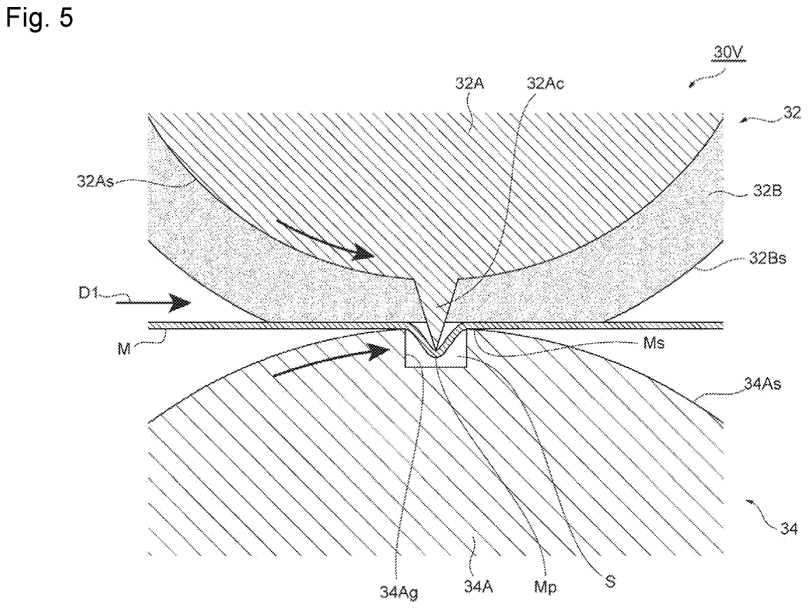

FIG. 5 is a process cross-sectional view schematically illustrating a main part of a punching step in a method for manufacturing a ribbon piece according to a modification of the first embodiment.

As illustrated in FIG. 5, a rotary die cutter 30V according to the modification is different from the rotary die cutter 30 according to the first embodiment only in that the anvil roll 34 includes the anvil roll body 34A and does not include the anvil roll elastic layer 34B. In the method for manufacturing a ribbon piece according to the modification, different from the method for manufacturing a ribbon piece according to the first embodiment, in the punching step, the rotary die cutter 30V is used, and the die roll 32 and the anvil roll 34 are rotated in mutually opposite directions as indicated by arrows while sandwiching the ribbon material M between the outer peripheral surface 32Bs of the die roll elastic layer 32B and the outer peripheral surface 34As of the anvil roll body 34A. Accordingly, the ribbon material M is passed through between the die roll 32 and the anvil roll 34. At this time, while sandwiching and pressing the ribbon material M between the die roll elastic layer 32B and the adjacent region in both sides of the groove 34Ag of the outer peripheral surface 34As of the anvil roll body 34A such that the adjacent region in both sides of the groove 34Ag of outer peripheral surface 34As of the anvil roll body 34A directly contacts the ribbon material M, the cutting blade 32Ac of the die roll body 32A is engaged with (loosely fitted into) the groove 34Ag of the anvil roll body 34A with the space S between the cutting blade 32Ac and the inside surface of the groove 34Ag, and pressed onto the ribbon material M. Accordingly, in the adjacent region in both sides of the groove 34Ag of the anvil roll body 34A, the sandwiched portion Ms sandwiched and pressed between the die roll elastic layer 32B and the anvil roll body 34A in the ribbon material M is restrained by the elastic force of the die roll elastic layer 32B. At the same timing, by projecting the cutting blade 32Ac of the die roll body 32A from the outer peripheral surface 32Bs of the die roll elastic layer 32B, the press position Mp of the ribbon material M at which the cutting blade 32Ac is pressed onto the ribbon material M is pressed down by the cutting blade 32Ac of the die roll body 32A. Thus, the tensile stress due to restraining is applied to the press position Mp of the ribbon material M together with the tensile stress due to bending, thereby cutting the ribbon material M at the press position Mp. Thus, the ribbon piece P is punched out.

The method for manufacturing a ribbon piece according to the modification provides an effect similar to that of the method for manufacturing a ribbon piece according to the first embodiment except an effect obtained depending on the condition of hardness of the anvil roll elastic layer 34B.

### Second Embodiment

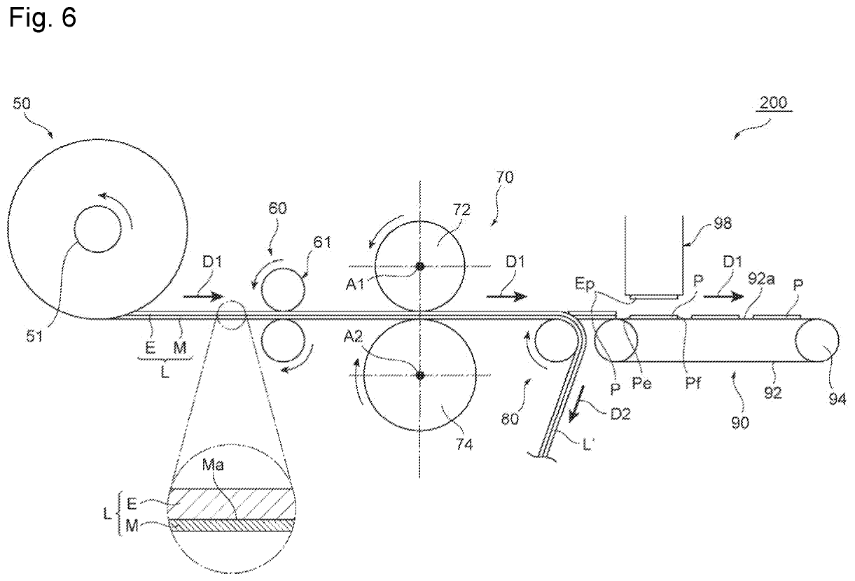

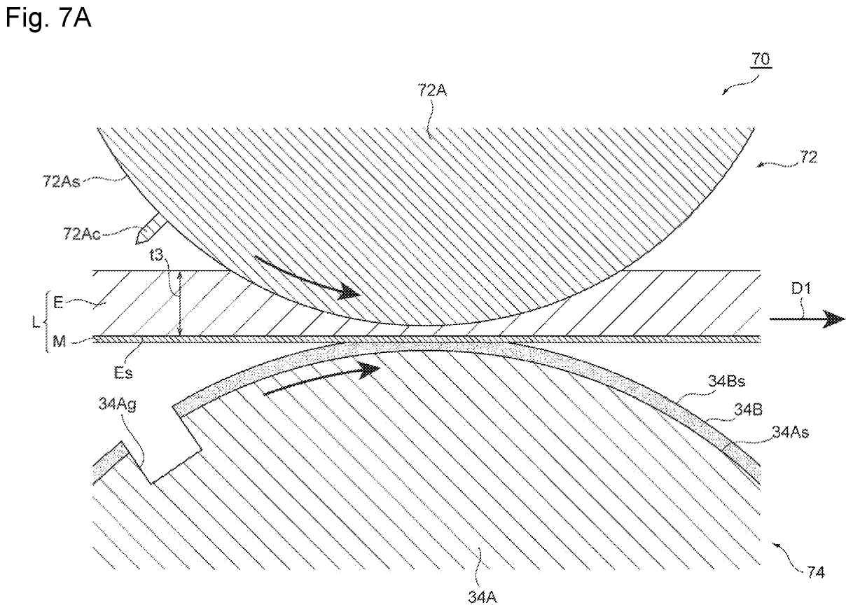

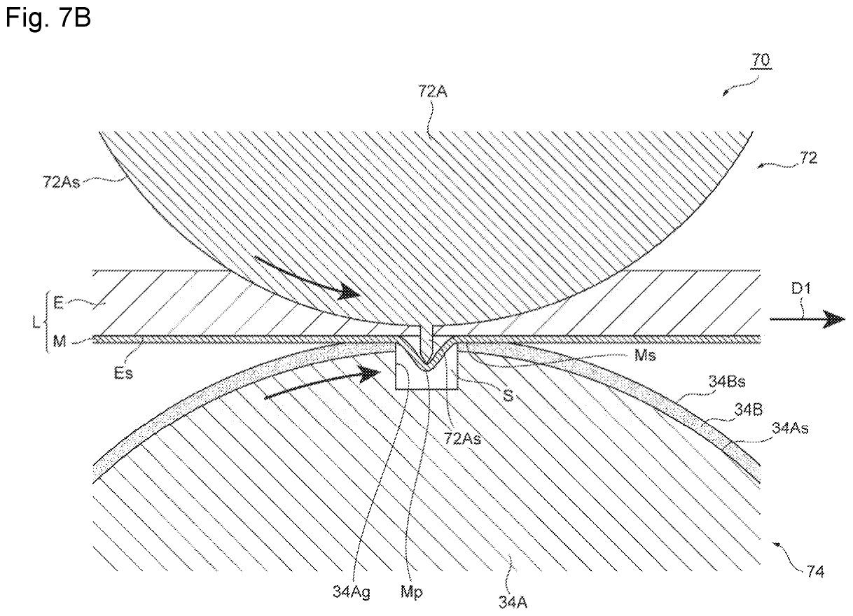

FIG. 6 is a side view schematically illustrating manufacturing equipment to perform a method for manufacturing a ribbon piece according to the second embodiment. FIG. 7A and FIG. 7B are process cross-sectional views schematically illustrating a punching step in the method for manufacturing a ribbon piece according to the second embodiment.

As illustrated in FIG. 6, manufacturing equipment 200 to perform the method for manufacturing a ribbon piece according to the second embodiment includes a material supply device 50, a material conveyance device 60, a rotary die cutter 70, a separation roll 80, a product conveyance device 90, and a suction device 98, which are sequentially disposed in a conveyance direction D1.

The material supply device 50 includes a rotation shaft 51 disposed to be rotatable in an arrow direction so as to unroll a laminated sheet L and supply the laminated sheet L to the rotary die cutter 70. The laminated sheet L is wound around the rotation shaft 51. The laminated sheet L includes a ribbon material (a thin belt material) M and an elastic sheet (die roll side elastic body) E placed on a surface Ma of the ribbon material M in a die roll 72 side described later. The ribbon material M is an amorphous alloy ribbon. The material conveyance device 60 includes a pair of conveyance rolls 61 that rotate while sandwiching the laminated sheet L therebetween. The pair of conveyance rolls 61 are disposed so as to have rotation axes parallel to one another, and rotate in mutually opposite directions as indicated by arrows, thus conveying the laminated sheet L while sandwiching the laminated sheet L therebetween. The separation roll 80 is disposed so as to have a rotation axis parallel to the rotation axis of the conveyance roll 61. In the product conveyance device 90, a belt 92 is wound around a pair of pulleys 94, a magnet (not illustrated) is disposed inside the belt 92 along a conveyance surface 92a of the belt 92. The pair of pulleys 94 are disposed so as to have rotation axes parallel to the rotation axis of the separation roll 80, and the belt 92 is disposed such that the conveyance surface 92a moves in the conveyance direction D1 in association with the rotation of the pulleys 94. The suction device 98 is disposed above the conveyance surface 92a of the belt 92.

In the manufacturing equipment 200, first, the laminated sheet L supplied from the material supply device 50 is conveyed to the rotary die cutter 70 by the material conveyance device 60. Next, by performing a method for manufacturing a ribbon piece (a thin strip) according to the second embodiment by the rotary die cutter 70, and the ribbon piece (a thin strip) P illustrated in FIG. 2 is repeatedly punched out from the ribbon material M of the laminated sheet L, thereby manufacturing a plurality of the ribbon pieces P. At this time, the ribbon piece P is punched from the ribbon material M so as to have the flat peripheral edge Pf side facing in the conveyance direction D1. Next, the plurality of punched ribbon pieces P are sequentially conveyed in the conveyance direction D1 with intervals between the punched ribbon pieces P in the conveyance direction D1 by the rotation of the separation roll 80 in a state where the flat peripheral edge Pf sides of the punched ribbon pieces P are faced in the conveyance direction D1. The flat peripheral edge Pf sides are sequentially placed on the conveyance surface 92a of the belt 92 of the product conveyance device 90, and suctioned by a magnetic force of the magnet. At the same time, a punched laminated sheet L′ is conveyed in a direction D2 by the rotation of the separation roll 80, and separated from the ribbon piece P. Next, while the conveyance surface 92a of the belt 92 is moved by the rotation of the pulleys 94 of the product conveyance device 90 to convey the plurality of ribbon pieces P placed on the conveyance surface 92a in the conveyance direction D1, sheet pieces Ep, which are punched from the elastic sheet E at the punching of the ribbon pieces P, are suctioned and removed from the respective ribbon pieces P by the suction device 98. Thus the plurality of ribbon pieces P are collected. The following describes the rotary die cutter 70 and the method for manufacturing a ribbon piece according to the second embodiment in detail.

As illustrated in FIG. 6, FIG. 7A, and FIG. 7B, the rotary die cutter 70 includes a die roll 72 and an anvil roll 74. The die roll 72 includes a die roll body 72A. The die roll body 72A has a configuration similar to that of the die roll body 32A according to the first embodiment except that a cutting blade 72Ac has a cross-sectional shape that is triangular only near the blade edge. The die roll 72 rotates in an arrow direction about a rotation axis A1 of the die roll body 72A while pressing the ribbon material M by the die roll body 72A via the elastic sheet E. The anvil roll 74 has a configuration similar to that of the anvil roll 34 according to the first embodiment, and rotates similarly to the anvil roll 34 according to the first embodiment.

In the rotary die cutter 70, a width of a base portion of the cutting blade 72Ac of the die roll body 72A is equal to or less than a width of the groove 34Ag of the anvil roll body 34A. The width of the groove 34Ag is set such that a clearance between the blade edge of the cutting blade 72Ac and the edge of the groove 34Ag is increased to, for example, about five times of the thickness of the ribbon material M. The elastic sheet E has a thickness t3 larger than a height of the cutting blade 72Ac. Since the elastic sheet E is made of a resin sponge sheet, the anvil roll elastic layer 34B has a hardness (Shore A) three times or more of a hardness (Shore A) of the elastic sheet E. The height of the cutting blade 72Ac and a clearance between the roll bodies 72A, 34A are set such that a depth of the cutting blade 72Ac pressed into the groove 34Ag is increased to, for example, about five times of the thickness of the ribbon material M.

In the method for manufacturing a ribbon piece according to the second embodiment, the ribbon piece P is repeatedly punched from the ribbon material M of the laminated sheet L using the rotary die cutter 70 (punching step). In the punching step, as illustrated in FIG. 7A and FIG. 7B, the die roll 72 and the anvil roll 74 are rotated in the mutually opposite directions as indicated by the arrows while sandwiching the laminated sheet L between an outer peripheral surface 72As of the die roll body 72A and the outer peripheral surface 34Bs of the anvil roll elastic layer 34B. Accordingly, the laminated sheet L is passed through between the die roll 72 and the anvil roll 74, thereby causing the ribbon material M of the laminated sheet L to pass through between the die roll 72 and the anvil roll 74. At this time, while sandwiching and pressing the ribbon material M between the elastic sheet E disposed at the adjacent region in both sides of the base portion of the cutting blade 72Ac on the outer peripheral surface 72As of the die roll body 72A and the anvil roll elastic layer 34B by pressing the ribbon material M by the die roll body 72A via the elastic sheet E and supporting the ribbon material M by the anvil roll elastic layer 34B, the cutting blade 72Ac of the die roll body 72A is engaged with (loosely fitted into) the groove 34Ag of the anvil roll body 34A with the space S between the cutting blade 72Ac and the inside surface of the groove 34Ag, and pressed onto the ribbon material M.

Accordingly, in the adjacent region in both sides of the groove 34Ag of the anvil roll body 34A, a sandwiched portion Ms sandwiched and pressed between the elastic sheet E and the anvil roll elastic layer 34B in the ribbon material M is restrained by elastic forces of both of the elastic sheet E and the anvil roll elastic layer 34B. At the same timing, by projecting the cutting blade 72Ac of the die roll body 72A from a surface Es in the ribbon material M side of the elastic sheet E, a press position Mp of the ribbon material M at which the cutting blade 72Ac is pressed onto the ribbon material M is pressed down by the cutting blade 72Ac of the die roll body 72A. Thus, a tensile stress due to restraining is applied to the press position Mp of the ribbon material M together with a tensile stress due to bending, thereby cutting the ribbon material M at the press position Mp.

By continuously rotating the die roll 72 and the anvil roll 74, the cutting of the ribbon material M as described above is continuously performed, and the ribbon piece P is repeatedly punched from the ribbon material M, thereby manufacturing a plurality of the ribbon pieces P.

According to the method for manufacturing a ribbon piece of the second embodiment, similarly to the first embodiment, since the ribbon material M can be punched by causing the tensile stress due to bending and the tensile stress due to restraining to act on the press position Mp of the ribbon material M, the damage of the rotary die cutter 70 can be suppress ed.

Since the width of the base portion of the cutting blade 72Ac of the die roll body 72A is equal to or less than the width of the groove 34Ag of the anvil roll body 34A, the sandwiched portion Ms of the ribbon material M can be restrained by the elastic force of the elastic sheet E in the adjacent region in both sides of the groove 34Ag of the anvil roll body 34A without a delay to the timing of pressing the cutting blade 72Ac of the die roll body 72A onto the ribbon material M. Accordingly, it can be avoided that the ribbon material M enters the groove 34Ag, thus allowing the tensile stress due to restraining to act on the press position Mp of the ribbon material M with a magnitude enough for the cutting.

Since the ribbon material M can be cut by engaging the cutting blade 72Ac of the die roll body 72A with the groove 34Ag of the anvil roll body 34A with the space S and pressing the cutting blade 72Ac onto the ribbon material M, similarly to the first embodiment, the phase matching between the die roll 72 and the anvil roll 74 is facilitated.

Furthermore, the hardness (Shore A) of the anvil roll elastic layer 34B is three times or more of the hardness (Shore A) of the elastic sheet E. Therefore, by supporting the ribbon material M by the hard anvil roll elastic layer 34B and pressing the ribbon material M by the soft elastic sheet E, the deformation of the sandwiched portion Ms of the ribbon material M can be suppressed, thus allowing strongly restraining the sandwiched portion Ms of the ribbon material M. Accordingly, the ribbon material M can be surely cut at the press position Mp, and the ribbon piece P can be punched out from the ribbon material M with an accuracy of the shape in plan view of the blade edge of the cutting blade 32Ac.

### (Modification of Second Embodiment)

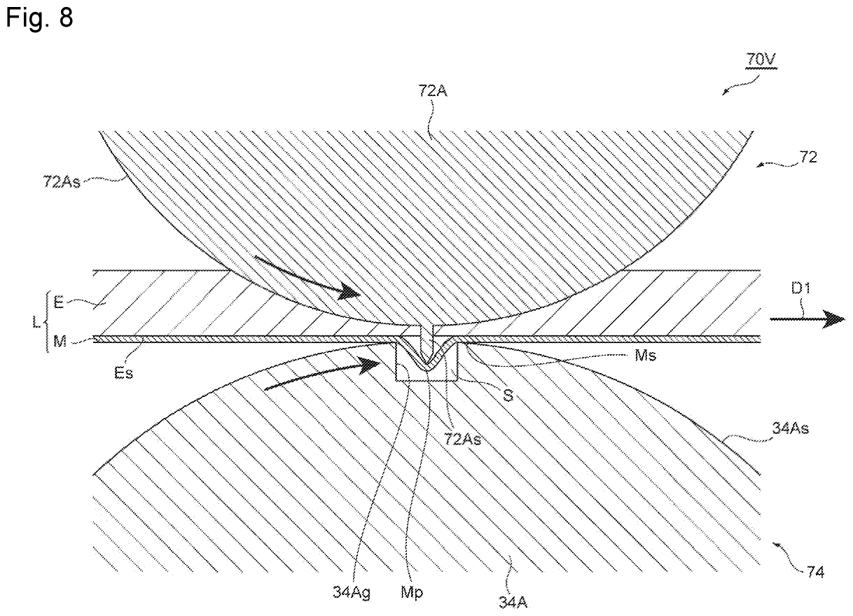

FIG. 8 is a process cross-sectional view schematically illustrating a main part of a punching step in a method for manufacturing a ribbon piece according to a modification of the second embodiment.

As illustrated in FIG. 8, a rotary die cutter 70V according to the modification is different from the rotary die cutter 70 according to the second embodiment only in that the anvil roll 74 includes the anvil roll body 34A and does not include the anvil roll elastic layer 34B. In the method for manufacturing a ribbon piece according to the modification, different from the method for manufacturing a ribbon piece according to the second embodiment, in the punching step, the die roll 72 and the anvil roll 74 are rotated in the mutually opposite directions as indicated by the arrows while sandwiching the laminated sheet L between the outer peripheral surface 72As of the die roll body 72A and the outer peripheral surface 34As of the anvil roll body 34A using the rotary die cutter 70V. Accordingly, the ribbon material M of the laminated sheet L is passed through between the die roll 72 and the anvil roll 74. At this time, while sandwiching and pressing the ribbon material M between the elastic sheet E and the adjacent region in both sides of the groove 34Ag of the outer peripheral surface 34As of the anvil roll body 34A by pressing the ribbon material M by the die roll body 72A via the elastic sheet E and supporting the ribbon material M by the anvil roll body 34A such that the adjacent region in both sides of the groove 34Ag of the outer peripheral surface 34As of the anvil roll body 34A directly contacts the ribbon material M, the cutting blade 72Ac of the die roll body 72A is engaged with (loosely fitted into) the groove 34Ag of the anvil roll body 34A with the space S between the cutting blade 72Ac and the inside surface of the groove 34Ag, and pressed onto the ribbon material M. Accordingly, in the adjacent region in both sides of the groove 34Ag of the anvil roll body 34A, the sandwiched portion Ms sandwiched and pressed between the elastic sheet E and the anvil roll body 34A in the ribbon material M is restrained by the elastic force of the elastic sheet E. At the same timing, by projecting the cutting blade 72Ac of the die roll body 72A from the surface Es in the ribbon material M side of the elastic sheet E, the press position Mp of the ribbon material M at which the cutting blade 72Ac is pressed onto the ribbon material M is pressed down by the cutting blade 72Ac of the die roll body 72A. Thus, a tensile stress due to restraining is applied to the press position Mp of the ribbon material M together with a tensile stress due to bending, thereby cutting the ribbon material M at the press position Mp. Thus, the ribbon piece P is punched.

The method for manufacturing a ribbon piece according to the modification provides an effect similar to that of the method for manufacturing a ribbon piece according to the second embodiment except an effect obtained depending on the condition of hardness of the anvil roll elastic layer 34B.

Subsequently, the configurations in the methods for manufacturing a ribbon piece according to the embodiments will be each described in detail.

### 1. Rotary Die Cutter

The rotary die cutter includes a die roll and an anvil roll. The die roll includes a die roll body with a cutting blade formed to protrude on the outer peripheral surface of the die roll body, and the shape of the cutting blade corresponds to a peripheral edge of the ribbon piece. The anvil roll includes an anvil roll body provided with a groove on the outer peripheral surface of the anvil roll body, and the cutting blade of the die roll body is engageable with the groove with a space.

While the rotary die cutter is not specifically limited, for example, as described in the first embodiment, the die roll may further include a die roll elastic layer disposed in both sides of a base portion of the cutting blade on the outer peripheral surface of the die roll body. In this case, in the punching step described later, the die roll elastic layer may be configured as a die roll side elastic body. In the rotary die cutter, for example, as described in the second embodiment, the die roll does not need to include the die roll elastic layer. In this case, in the punching step described later, an elastic sheet of a laminated sheet described later may be configured as a die roll side elastic body.

While the rotary die cutter is not specifically limited, for example, the anvil roll may further include an anvil roll elastic layer disposed in both sides of the groove of the outer peripheral surface of the anvil roll body as described in the first and the second embodiments, or the anvil roll does not need to include the anvil roll elastic layer as described in the modifications of the first and the second embodiments.

While the die roll body of the die roll is not specifically limited, for example, the die roll body of the die roll is a column-shaped die, and rotatably provided having its central axis as a rotation axis. The outer peripheral surface of the die roll body may be, for example, a smooth cylindrical surface without unevenness, or may be provided with a protruding portion or a recessed portion for securing the die roll elastic layer on the cylindrical surface. While the constituent material of the die roll body is not specifically limited, for example, alloy tool steels (material code: SKD) for cold work dies and high speed tool steels (material code: SKH) specified in Japanese Industrial Standards JIS G 4403:2015 and G 4404:2015, and high speed tool steels (material code: HAP) manufactured by Hitachi Metals, Ltd. are included.

For the cutting blade of the die roll body, the term “the shape of the cutting blade corresponds to a peripheral edge of the ribbon piece” means that when the outer peripheral surface of the die roll body is expanded into a plane (developed into a plane shape), the blade edge of the cutting blade is the same as the peripheral edge of the ribbon piece in shape in plan view. The cutting blade may be a part of the die roll body, or may be a member separated from the die roll body. When the cutting blade is a separated member, the cutting blade is made of a hard material such as a metal.

While the die roll elastic layer of the die roll is not specifically limited insofar as the die roll elastic layer of the die roll is disposed in both sides of the base portion of the cutting blade on the outer peripheral surface of the die roll body, the die roll elastic layer of the die roll may extend to the adjacent region of the base portion of the cutting blade as described in the first and the second embodiments. For example, the die roll elastic layer is provided to be secured to the outer peripheral surface of the die roll body by adhesive bonding, welding, mechanical joining, or the like. While the type of the die roll elastic layer is not specifically limited, for example, foam sheets and sponge sheets made of foamed resins, such as urethane and ethylene vinyl acetate (EVA), are included. The type of the elastic sheet of the laminated sheet described later is similar to the type of the die roll elastic layer.

While the anvil roll body of the anvil roll is not specifically limited, for example, the anvil roll body of the anvil roll is a column-shaped die, and rotatably provided having its central axis as a rotation axis. The outer peripheral surface of the anvil roll body may be, for example, a smooth cylindrical surface without unevenness, or may be provided with a protruding portion or a recessed portion for securing the anvil roll elastic layer on the cylindrical surface. Since the constituent material of the anvil roll body is similar to the constituent material of the die roll body, the explanation is omitted here.

For the groove of the anvil roll body, the term “the cutting blade of the die roll body is engageable with the groove with a space” means that the cutting blade of the die roll body can be engaged with (loosely fitted into) the groove of the anvil roll body with a space between the cutting blade and the inside surface of the groove, and the groove of the anvil roll body has a shape and dimensions allowing punching out the ribbon piece in the punching step. The shape in plan view of the groove when the outer peripheral surface of the anvil roll body is expanded into a plane (developed into a plane shape) is usually approximately the same as the outline shape of the ribbon piece, and has a shape that can include the shape in plan view of the blade edge of the cutting blade when the outer peripheral surface of the die roll body is expanded into a plane (developed into a plane shape).

While the anvil roll elastic layer of the anvil roll is not specifically limited insofar as the anvil roll elastic layer of the anvil roll is disposed in both sides of the groove of the outer peripheral surface of the anvil roll body, the anvil roll elastic layer of the anvil roll may extend to the adjacent region in both sides of the groove as described in the first and the second embodiments. For example, the anvil roll elastic layer is disposed to be secured to the outer peripheral surface of the anvil roll body by adhesive bonding, welding, mechanical joining, or the like. While the type of the anvil roll elastic layer is not specifically limited, for example, non-foamed resin sheets made of non-foamed resins, such as urethane, rubber, and PET, are included.

While the width of the base portion of the cutting blade of the die roll body is not specifically limited, the width of the base portion of the cutting blade of the die roll body may be equal to or less than the width of the groove of the anvil roll body as described in the first and the second embodiments. Here, the term “width of the base portion of the cutting blade” is a width of the base portion of the cutting blade in the outer peripheral surface side of the die roll body, and means a dimension in a direction perpendicular to the extending direction of the cutting blade on the outer peripheral surface of the die roll body. The term “width of the groove” is a width of an opening portion of the groove of the anvil roll body, and means a dimension in a direction perpendicular to the extending direction of the groove on the outer peripheral surface of the anvil roll body.

While the thickness of the die roll side elastic body is not specifically limited, the thickness of the die roll side elastic body may be larger than the height of the cutting blade of the die roll body as described in the first and the second embodiments. This is because the ribbon material can be strongly restrained by the die roll side elastic body at the timing of pressing the cutting blade of the die roll body onto the ribbon material. The thickness of the die roll side elastic body is, for example, four times or less of the height of the cutting blade in some embodiments, and may be three times or less of the height of the cutting blade. The height of the cutting blade is, for example, approximately 0.2 mm. Here, the term “thickness of the die roll elastic layer” means a dimension in a radial direction of the die roll body of the die roll elastic layer without an elastic deformation. The term “height of the cutting blade” means a dimension of the cutting blade from the base portion in the outer peripheral surface side of the die roll body to the blade edge in the radial direction of the die roll body.

While the hardness of the anvil roll elastic layer is not specifically limited, the hardness of the anvil roll elastic layer may be higher than the hardness of the die roll side elastic body as described in the first and the second embodiments, and is three times or more of the hardness of the die roll side elastic body in some embodiments. This is because the deformation of the sandwiched portion of the ribbon material caused by pressing down the press position of the ribbon material M can be suppressed, thus allowing strongly restraining the sandwiched portion of the ribbon material by the die roll side elastic body and the anvil roll elastic layer. Here, the term “hardness” means a hardness, for example, measured by a method specified in Japanese Industrial Standards JIS K 6253-3:2012 or JIS K 7312:1996. That is, for example, a durometer hardness of type A (Shore A) corresponds.

The term “clearance between the blade edge of the cutting blade of the die roll body and the edge of the groove of the anvil roll body” means a dimension in the width direction of the groove between the blade edge of the cutting blade and the edge of the opening portion of the groove when the blade edge of the cutting blade comes at the deepest position inside the groove. The term “depth of the cutting blade pressed into the groove” means a dimension between the opening surface of the groove and the blade edge of the cutting blade when the blade edge of the cutting blade comes at the deepest position inside the groove. The term “clearance between the roll bodies” means a distance between the outer peripheral surface of the anvil roll body and the outer peripheral surface of the die roll body on a straight line perpendicular to the rotation axis of the anvil roll body and the rotation axis of the die roll body.

### 2. Method for Manufacturing Ribbon Piece

The method for manufacturing a ribbon piece (a thin strip) includes a punching step of punching out a ribbon piece (a thin strip) from a ribbon material (a thin belt material) using the rotary die cutter.

### (1) Punching Step

In the punching step, the ribbon material is cut by engaging the cutting blade of the die roll body with the groove of the anvil roll body with a space and pressing the cutting blade of the die roll body onto the ribbon material while sandwiching and pressing the ribbon material between the die roll side elastic body disposed in both sides of the base portion of the cutting blade on the outer peripheral surface of the die roll body and both sides of the groove of the outer peripheral surface of the anvil roll body when the ribbon material is passed through between the die roll and the anvil roll by rotating the die roll and the anvil roll in the mutually opposite directions, so as to punch out the ribbon piece from the ribbon material.

When the die roll further includes the die roll elastic layer, in the punching step, the die roll elastic layer may be configured as the die roll side elastic body as described in the first embodiment. In the punching step, as described in the second embodiment, a laminated sheet including the ribbon material and an elastic sheet placed on the surface in the die roll side of the ribbon material may be passed through between the die roll and the anvil roll to cause the ribbon material to pass through between the die roll and the anvil roll, and the elastic sheet may be configured as the die roll side elastic body.

When the anvil roll further includes the anvil roll elastic layer, in the punching step, as described in the first and the second embodiments, the ribbon material may be sandwiched and pressed between the die roll side elastic body and the anvil roll elastic layer. When the anvil roll does not include the anvil roll elastic layer, in the punching step, as described in the modifications of the first and the second embodiments, the ribbon material may be sandwiched and pressed between the die roll side elastic body and both sides of the groove of the outer peripheral surface of the anvil roll body such that both sides of the groove of the outer peripheral surface of the anvil roll body directly contact the ribbon material.

### (2) Others

While the ribbon material is not specifically limited insofar as the ribbon piece can be punched, the ribbon material has Vickers hardness in a range of 300 HV or more and 900 HV or less in some embodiments, and an amorphous alloy ribbon or the like may be used. This is because the effect of suppressing the damage of the rotary die cutter is remarkable. The term “Vickers hardness” means, for example, a Vickers hardness of a ribbon material when a test force is 0.01 kgf and a test force duration is 10 seconds in a Vickers hardness test based on JIS Z 2244 (2009).

While the thickness of the ribbon material is not specifically limited insofar as the ribbon piece can be punched, and differs depending on the type of the ribbon material, for example, the thickness of the ribbon material is in a range of 20 μm or more and 30 μm or less in a case of an amorphous alloy ribbon.

While the ribbon piece (the thin strip) is not specifically limited, examples of the ribbon piece include a ribbon piece (a thin strip) constituting each layer of a laminated core, such as a stator core and a rotor core, of a motor for automobile use or the like, a ribbon piece (a thin strip) obtained by further dividing the ribbon piece in a circumferential direction, and the like.

### Example

The following further specifically describes the method for manufacturing a ribbon piece according to the embodiments with an example.

### Example

First, the method for manufacturing a ribbon piece according to the first embodiment was performed with actual equipment. Specifically, first, as a rotary die cutter of the actual equipment, one having a configuration below was prepared. As a ribbon material, an amorphous alloy ribbon (thickness: about 20 μm to 30 μm) was prepared.

### (Configuration of Rotary Die Cutter)

Die Roll Body (Die of Upper Roll)

Outer diameter: predetermined value

Height h of cutting blade: predetermined value

Width W1 of base portion of cutting blade: predetermined value (equal to or less than width of groove of anvil roll body)

Die Roll Elastic Layer (Resin of Upper Roll)

Thickness t1: predetermined value

Hardness (Shore A): predetermined value (⅓ or less of anvil roll elastic layer)

Anvil roll body (die of lower roll)

Outer diameter: predetermined value Width W2 of groove: predetermined value

Anvil roll elastic layer (resin of lower roll)

Thickness t2: predetermined value

Hardness (Shore A): predetermined value (three times or more of hardness of die roll elastic layer (Shore A))

Rotary die cutter

Clearance between blade edge of cutting blade of die roll body and edge of groove of anvil roll body: set to five times of thickness of ribbon material

Clearance d between roll bodies (die roll body and anvil roll body): set depth of cutting blade of die roll body pressed into groove of anvil roll body to five times of thickness of ribbon material

Next, a test of repeatedly punching out a ribbon piece from the amorphous alloy ribbon was performed using the rotary die cutter of the actual equipment under a predetermined punching condition (punching step). Consequently, the ribbon piece was able to be repeatedly punched out from the amorphous alloy ribbon, and a plurality of the ribbon pieces were able to be manufactured.

While the embodiments of the present disclosure have been described in detail, the present disclosure is not limited to the embodiments, and various changes in design are possible within the scope of not departing from the spirit of the present disclosure described in the claims.

All publications, patents and patent applications cited in the present description are herein incorporated by reference as they are.

### DESCRIPTION OF SYMBOLS

30 Rotary die cutter
32 Die roll
32A Die roll body
32As Outer peripheral surface
32Ac Cutting blade
32B Die roll elastic layer
32Bs Outer peripheral surface
34 Anvil roll
34A Anvil roll body
34As Outer peripheral surface
34Ag Groove
34B Anvil roll elastic layer
34Bs Outer peripheral surface
M Ribbon material
Mp Press position
P Ribbon piece
70 Rotary die cutter
72 Die roll
72A Die roll body
74 Anvil roll
L Laminated sheet
E Elastic sheet
Es Surface in ribbon material side

What is claimed is:

1. A method for manufacturing a ribbon piece, comprising
punching out a ribbon piece from a ribbon material using a rotary die cutter, the rotary die cutter including a die roll and an anvil roll,
wherein the die roll includes a die roll body, and a cutting blade, the shape of which corresponds to a peripheral edge of the ribbon piece, is formed to protrude on an outer peripheral surface of the die roll body,
wherein the anvil roll includes an anvil roll body, a groove is provided on an outer peripheral surface of the anvil roll body, and the cutting blade of the die roll body is engageable with the groove with a space, and
wherein, in the punching, the ribbon material is cut by engaging the cutting blade of the die roll body with the groove of the anvil roll body with a space and pressing the cutting blade of the die roll body onto the ribbon material while sandwiching and pressing the ribbon material between a die roll side elastic body disposed in both sides of a base portion of the cutting blade on the outer peripheral surface of the die roll body and both sides of the groove of the outer peripheral surface of the anvil roll body when the ribbon material is passed through between the die roll and the anvil roll by rotating the die roll and the anvil roll in mutually opposite directions, so as to punch out the ribbon piece from the ribbon material.

2. The method for manufacturing a ribbon piece according to claim 1,
wherein the base portion of the cutting blade of the die roll body has a width equal to or less than a width of the groove of the anvil roll body.

3. The method for manufacturing a ribbon piece according to claim 1,
wherein the die roll further includes a die roll elastic layer disposed in both sides of the base portion of the cutting blade on the outer peripheral surface of the die roll body, and
wherein, in the punching, the die roll elastic layer is configured as the die roll side elastic body.

4. The method for manufacturing a ribbon piece according to claim 1,
wherein, in the punching, a laminated sheet including the ribbon material and an elastic sheet placed on a surface in the die roll side of the ribbon material is passed through between the die roll and the anvil roll to cause the ribbon material to pass through between the die roll and the anvil roll, and the elastic sheet is configured as the die roll side elastic body.

5. The method for manufacturing a ribbon piece according to claim 1,
wherein the anvil roll further includes an anvil roll elastic layer disposed in both sides of the groove of the outer peripheral surface of the anvil roll body, and
wherein, in the punching, the ribbon material is sandwiched and pressed between the die roll side elastic body and the anvil roll elastic layer.

6. The method for manufacturing a ribbon piece according to claim 1,
wherein, in the punching, the ribbon material is sandwiched and pressed between the die roll side elastic body and both sides of the groove of the outer peripheral surface of the anvil roll body such that both sides of the groove of the outer peripheral surface of the anvil roll body directly contact the ribbon material.
